(19) United States
(12) Patent Application Publication
(10) Pub. No.: US 2025/0149238 A1
(43) Pub. Date: May 8, 2025

(54) SYSTEMS AND METHODS FOR VARIABLE DIFFERENTIAL TRANSFORMERS SECONDARIES WITH SINGLE RAIL BIAS

(71) Applicant: Woodward, Inc., Fort Collins, CO (US)

(72) Inventor: Andrzej Jan Borzecki, Chicago, IL (US)

(21) Appl. No.: 18/500,282

(22) Filed: Nov. 2, 2023

(51) Int. Cl. H01F 29/10; G01D 5/22; H01F 27/02; H01F 27/40

(52) U.S. Cl. CPC H01F 29/10; G01D 5/2291; H01F 27/02; H01F 27/402

(57) ABSTRACT

Methods and systems for a variable differential transformer (VDT) system. The VDT system includes a primary coil to receive a power input, the primary coil balanced on opposing sides by two secondary coils. In response to movement of the core assembly, the secondary coils generate an induced voltage based on a voltage in the primary coil. A control system for measuring an output of the VDT includes a summing circuit to receive an output from two secondary coils. For instance, each of the two secondary coils generate an induced voltage in response changes in position of the core assembly relative to the primary coil and the two secondary coils. A voltage offset circuit adds a voltage offset value to a summing circuit output, which is transmitted to a single rail bias op-amp rectifier circuit.

### PRIORITY CLAIM/INCORPORATION BY REFERENCE

N/A

### FIELD

Certain embodiments of the disclosure relate to a system and/or method provided for a variable differential transformer (VDT) system. More specifically, the VDT system employs a single rail bias op-amp rectifier circuit.

### BACKGROUND

In many applications, variable differential transformers are used to measure changes in position or orientation of actuators or movable parts. However, there are a number of challenges associated with conventional, dual bias variable differential transformers. A solution to the use of conventional variable differential transformers is therefore desirable.

Further limitations and disadvantages of conventional and traditional approaches will become apparent to one of skill in the art, through comparison of such systems with the present disclosure as set forth in the remainder of the present application with reference to the drawings.

### BRIEF SUMMARY

A system and/or method is provided for a variable differential transformer (VDT) system. In particular, the VDT system employs a single rail bias op-amp rectifier circuit.

In disclosed examples, a control system for a variable differential transformer includes a summing circuit to receive an output from two secondary coils, each of the two secondary coils to generate an induced voltage in response changes in position of a core assembly relative to a primary coil and the two secondary coils. A rectifier circuit to receive a summing circuit output. A voltage offset circuit operable to add a voltage offset value to the summing circuit output; and remove the voltage value from the rectifier circuit output.

In some examples, an active filter is included to filter the rectifier circuit output.

In some examples, an active filter output is provided to an analog-to-digital-converter to generate an electronic signal corresponding to the changes in position of the core assembly.

In some examples, the active filter is a Sallen-Key type filter.

In some examples, the summing circuit is an adjustable gain type circuit.

In some examples, the rectifier circuit is a two-stage op-amp, full-wave rectifier type.

In some examples, the rectifier circuit is a single rail bias op-amp circuit.

In some examples, the variable differential transformer is a linear variable differential transformer.

In some disclosed examples, a variable differential transformer system includes a primary coil to receive a power input. A core assembly to move relative to the primary coil. Two secondary coils to generate an induced voltage based on a voltage in the primary coil in response to the movement of the core assembly. A control system includes a summing circuit to receive an output from two secondary coils, each of the two secondary coils to generate an induced voltage in response changes in position of the core assembly relative to a primary coil and the two secondary coils. A rectifier circuit to receive a summing circuit output. And a voltage offset circuit operable to add a voltage offset value to the summing circuit output.

In some examples, a Sallen-Key type filter is included to filter the rectifier circuit output.

In some examples, the rectifier circuit is a single rail bias op-amp circuit.

In some examples, the variable differential transformer is a linear variable differential transformer.

In some examples, the variable differential transformer is a rotatable variable

differential transformer.

In some examples, a housing is included to contain one or more of the primary coils, the core assembly, and the two secondary coils.

In some examples, the control system is collocated with the housing.

In some examples, the control system is remote from the housing.

In some examples, a method of implementing a control system to measure a change position or orientation of a variable differential transformer. The method includes receiving an output from two secondary coils at a summer circuit; applying an offset voltage to an output of the summer circuit; receiving the summer circuit output at an op-amp rectifier; receiving an op-amp rectifier output at a subtractor circuit; and removing the offset voltage from an output of the subtractor circuit.

In some examples, the method includes receiving the subtractor circuit output at a filter stage.

In some examples, the method includes receiving the filter stage output at an analog-to-digital-converter.

In some examples, the rectifier circuit is a single rail bias op-amp circuit.

These and various other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example variable differential transformer, in accordance with an example embodiment of the disclosure.

FIG. 2 illustrates a block diagram of an example control system for a variable differential transformer, in accordance with an example embodiment of the disclosure.

FIG. 3 illustrates an example method of programming a contactless potentiometer device comprising multi-channel sensors, in accordance with an example embodiment of the disclosure.

FIGS. 4A to 4E illustrate circuit stage output waveforms, in accordance with an example embodiment of the disclosure.

The figures are not necessarily to scale. Where appropriate, similar or identical reference numbers are used to refer to similar or identical components.

### DETAILED DESCRIPTION

Disclosed herein are systems and methods for a variable differential transformer (VDT) system. The VDT system includes a primary coil to receive a power input, the primary coil balanced on opposing sides by two secondary coils. In response to movement of the core assembly, the secondary coils generate an induced voltage based on a voltage in the primary coil.

Further disclosed is a control system for measuring an output of the VDT. The control system includes a summing circuit to receive an output from two secondary coils. For instance, each of the two secondary coils generate an induced voltage in response changes in position of the core assembly relative to the primary coil and the two secondary coils. A voltage offset circuit adds a voltage offset value to a summing circuit output, which is transmitted to a single rail bias op-amp rectifier circuit.

Advantages of the disclosed VDT and control systems will be explained with reference to conventional systems, provided below.

Closed loop control of an actuator requires a position sensor to indicate the instantaneous actuator position. Two example types of position sensors include a Rotary Variable Differential Transformer (RVDT) and Linear Variable Differential Transformer (LVDT). A VDT is a transformer whose secondary output level depends on the excitation level of the primary for a given turns ratio.

As with any transformer, the amplitude of secondary voltage will depend on the primary-to-secondary turns ratio, leakage, frequency, and coil composition, as a list of non-limiting factors. The level of secondary output may not be sufficient to exercise the full range of output of the rectification circuit, thereby limiting sensor resolution.

This secondary dependency on the primary excitation coil further limits flexibility at the hardware circuitry level and drives the design of the variable differential transformer (VDT) at the sensor level.

Another disadvantage is that when the secondary output switches polarity the op-amps used for scaling clip their output when the input switches from positive to negative. Some considered solutions to this challenge employ two separate voltage supplies for the op-amp rails. However, this requires additional parts in the electronic controller.

To overcome these challenges, the disclosed VDT secondary design utilizes a summer at a front end of the transformer fed into a single rail biased op-amp rectifier, followed by a logical subtractor and/or an active filter. The disclosed design enables a secondary feedback circuit to scale an output from secondary coils of the VDT to benefit from the complete full swing of the output stage while employing single rail bias op-amp rectifiers and minimizing negative impacts to output resolution. In some examples, the disclosed single rail bias design further reduces part count on the board of a single power supply.

The disclosed design employing the single rail biased rectifier provides improvements over existing solutions, which employ a dual rail bias which result in the above-mentioned challenges and disadvantageous. The solutions provided here ensure that polarity differences from each secondary coil is processed during a measurement.

For instance, the disclosed scalable VDT is operable to continue to resolve secondary outputs when transitioning to negative by adding an offset derived from a single voltage input or supply for the op-amp rail connected to the secondary outputs. The added offset can then be removed after rectification and filtering before the signal is read by the analog-to-digital-converter (ADC), the output of which can be transmitted to a controller.

As used herein, a variable differential transformer (VDT), or transducer, are devices used to monitor changes in position within a dynamic system. Advantageously, VDTs do not rely on contact to generate an output. Rather, VDTs measure changes in electromagnetic forces between a moving part (e.g., a probe and/or core assembly) and a (static) coil assembly. Frictionless by definition, the VDT yields a highly accurate output based on changes in the device. Such devices exhibit favorable hysteresis in operation and consistently repeatable outputs.

Moreover, the nature of a VDT makes the use of such a device resistant to wide ranges of temperatures, exposure to shock, and repeated use over long periods of time, making VDTs attractive over a wide range of applications (e.g., in transport, manufacturing, aircraft systems, satellites, etc.).

In operation, a VDT is configured to generate an electrical signal in response to a change in position or orientation. The electrical signal changes proportionately to the physical displacement (e.g., from a reference or null position), the electrical signal containing phase (e.g., based on the direction of the physical displacement) and/or amplitude (e.g., based on the distance of the physical displacement).

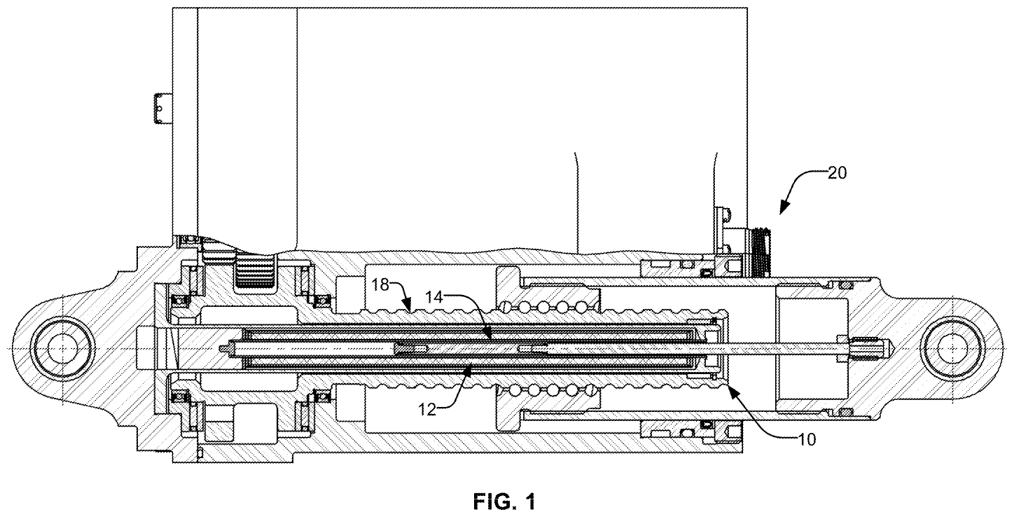

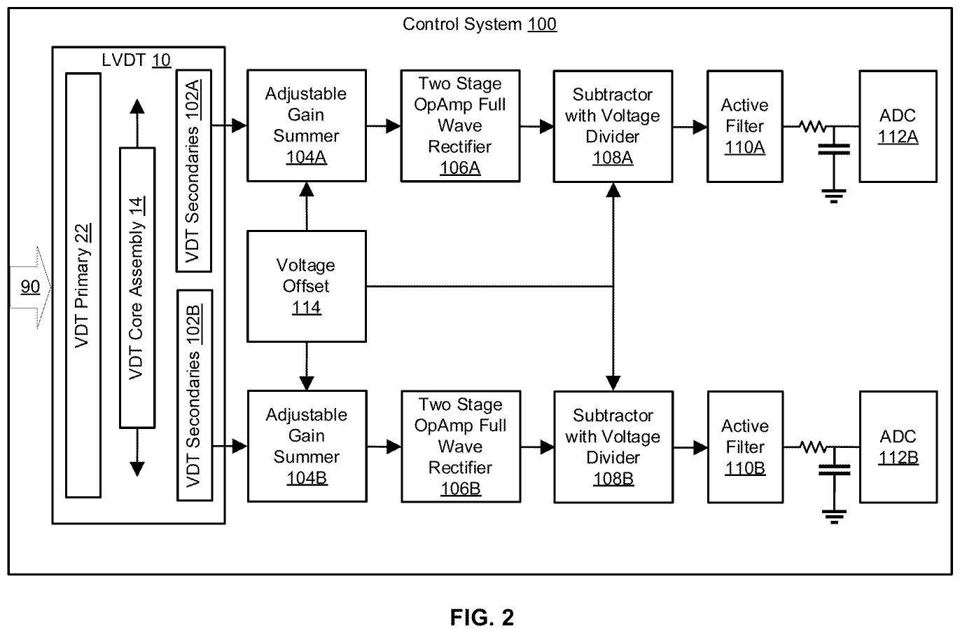

VDTs can come in different types, such as rotary and linear VDTs. FIG. 1 provides an example actuator 20 employing a linear variable differential transformer (LVDT) 10 equipped with a plurality of solenoidal coils arranged around a chamber 12 (e.g., a channel, tube, cylinder, etc.) though which a core assembly 14 moves. One coil (e.g., the center coil) serves as a primary coil, and one or more outer, secondary coils are arranged on opposite sides of the primary coil (as shown in example FIG. 2).

The core assembly (e.g., a cylindrical ferromagnetic device) can move within the chamber and/or be secured to a moveable object, for which changes in position are measured. Movement within the chamber can be facilitated by one or more ball bearings, bushings, tracks, or other support structure. The LVDT 10 can be housed in a frame or housing 18. In some examples, the housing 18 includes a panel 22, which provides access (via wired or wireless transmission) to one or more components (e.g., sensors, measurement circuits, control system 100) to allow for signal transfer in response to movement of the core assembly 14. In some examples, the components are arranged on or near the housing 18. In other examples, the components are located in a location remote from the housing 18.

An alternating current (AC) is applied to the primary coil and induces a current in the secondary coils, the associated voltage output of which is proportional to an amount of the core assembly linking to the primary coil to the secondary coil. As the core assembly moves within the chamber, the induced voltage changes. The secondary coils are connected such that a difference between the voltages measured on two opposing secondary coils is measured and corresponds to a change in the position of the core assembly. For example, at a central or neutral position, the core assembly is equally spaced (or overlapping) between the two secondaries. At this position, the voltages on the two secondary coils are equal, thereby cancelling the signals. As a result, a measured output voltage is substantially zero.

When the core assembly moves toward a first secondary coil, the voltage in the first secondary coil increases while the voltage in a second, opposite secondary coil decreases. As a result, the output voltage increases from substantially zero (e.g., from the null position). The measured output voltage is considered in phase with the voltage on the primary coil.

When the core assembly moves in the opposite direction (e.g., toward the second secondary coil), the value of the output voltage will increase from substantially zero, however, the phase will be opposite the phase associated with the voltage on the primary coil. Determining the phase of the output voltage is used to ascertain a direction of movement of the core assembly, while an amplitude of the output corresponds to the amount of movement/change in position.

FIG. 2 illustrates an example control system 100 for a linear variable differential transformers (LVDT) 12 to measure changes in position or movement of the LVDT. In some examples, the control system 100 is implemented as a series of circuit elements to process the various signals as disclosed herein. All or part of the control system 100 may be collocated with the LVDT 12, and/or all or part of the control system 100 may be remote from the LVDT 12 (and/or housing 18).

An AC excitation source 90 is introduced to the VDT primary coil 22. Changes in position of the core assembly 14 within the VDT causes the voltage on the secondary coils 102A, 102B of the transformer to change. In response to the movement of the core assembly 14, a voltage is induced in VDT secondary coils 102A, 102B, generating a pair of output signals corresponding to a position of the core assembly (e.g., displacement). The output signals from the secondary coils are received at adjustable gain summer(s) 104A, 104B.

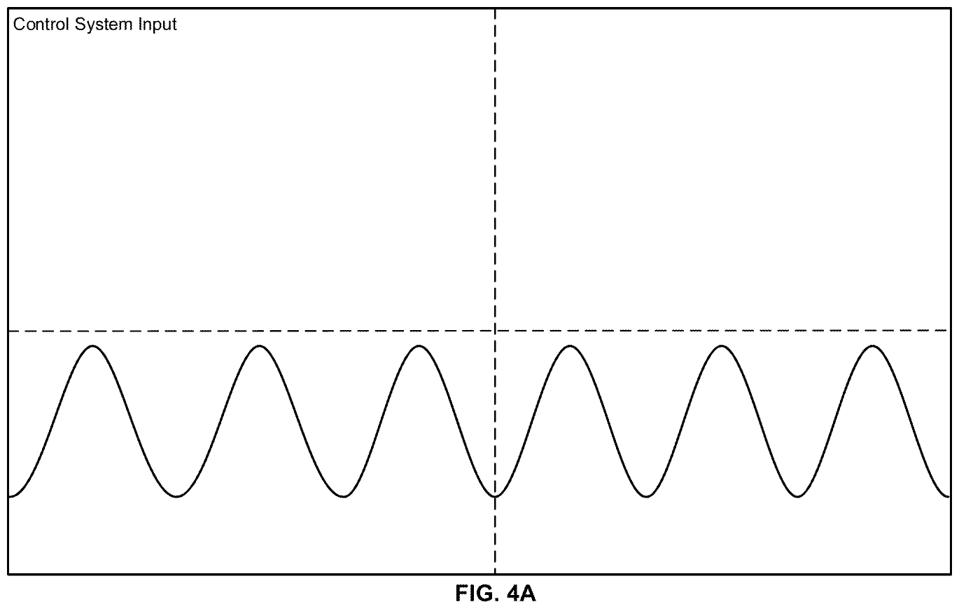

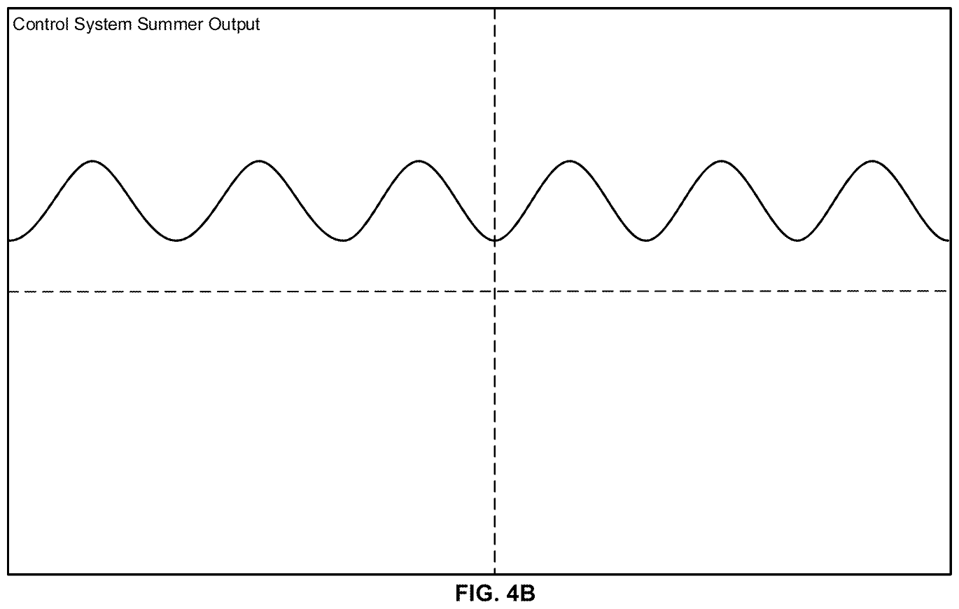

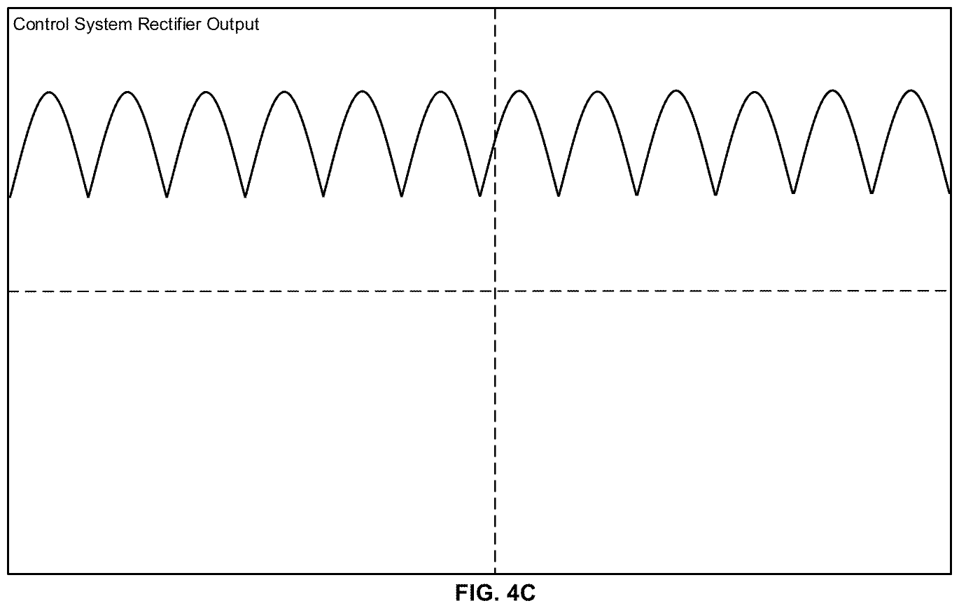

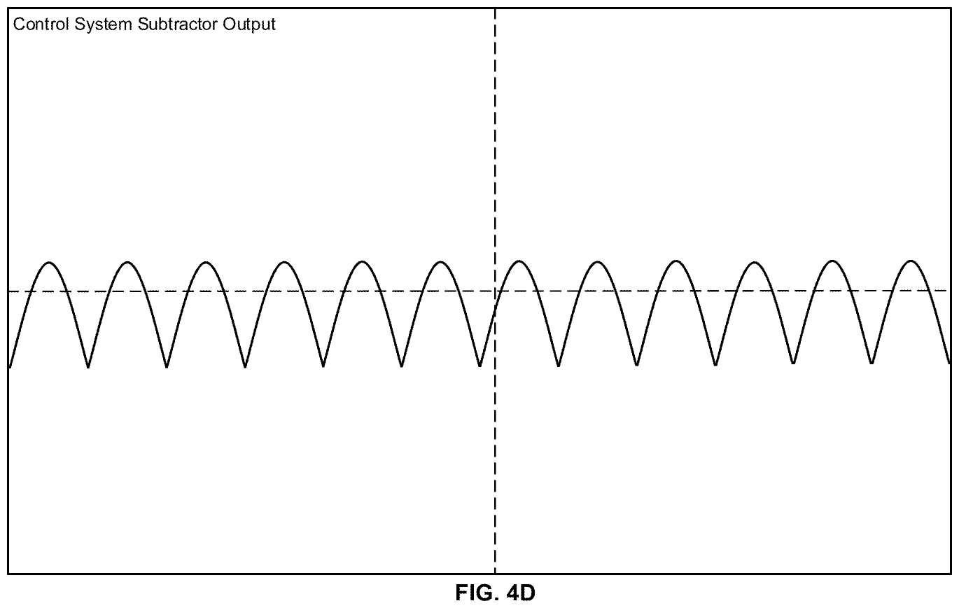

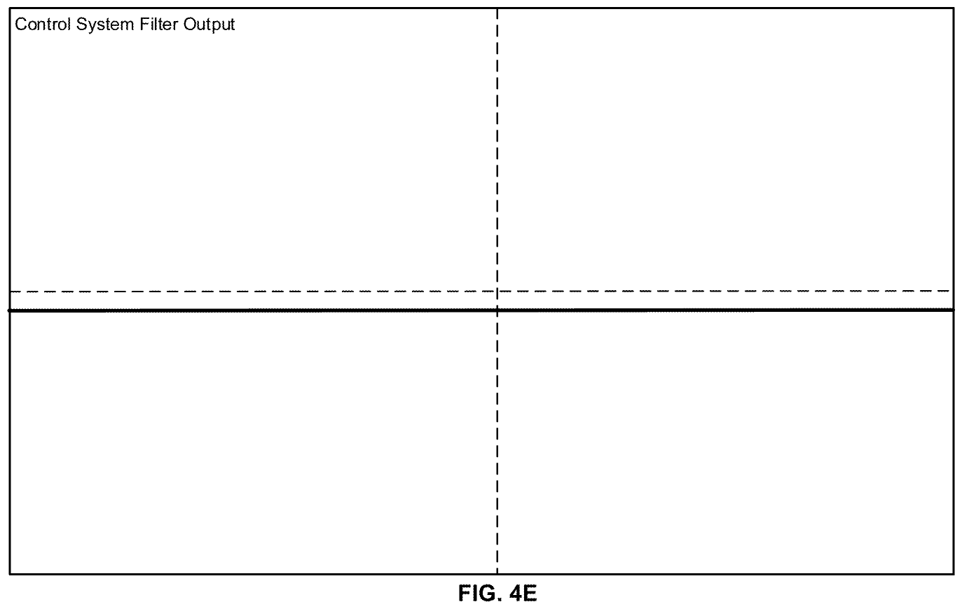

The voltage can be sensed and summed with an input voltage offset 114, which allows the input voltage on the secondary coils 102A, 102B to swing between a positive and a negative polarity relative to a null value (e.g., 0V). This stage, in combination with a subtracting stage (at 108A, 108B), where the offset voltage is removed, allows for a single rail bias on the VDT secondary circuit (see, e.g., FIGS. 4D and 4E).

For instance, the offset input voltage is fed into a dual stage op-amp full-wave rectifiers 106A, 106B to obtain an absolute value of the signals input from the secondary coils 102A, 102B. The output from the op-amp full-wave rectifiers 106A, 106B are provided to subtractors with voltage dividers 108A, 108B where, once polarity has stabilized (e.g., the position of the core is static), the previously added offset voltage can be removed through an active subtractor.

As a final filtering stage, an active filter is applied at 110A, 110B (e.g., via a Sallen-Key active filter) to obtain a voltage value that is proportional to the input signal amplitude and/or frequency, which is used to determine a position of the core assembly 14. The output from the active filter can be provided to an ADC 112A, 112B for transmission to a computing platform (e.g., control circuitry, a remote computer, etc.) for further analysis, storage, and/or display, as a list of non-limiting examples.

In some examples, the processes of summation and/or subtraction introduce small error(s) that may become more pronounced at the null value (e.g., 0V, or transition point) at one or both of the secondary coils that are accounted for during analysis.

Advantageously, the disclosed scalable VDT employs a single rail voltage supply, which greatly reduces cost and/or size of the linear actuator. The design is also scalable, enhancing applicability of the technology.

This disclosed scalable VDT therefore provides clear benefits over other designs, which may use two separate voltage supplies for the op-amps (e.g., op-amps 106A, 106B), thus increasing the number of components at the power supply stage.

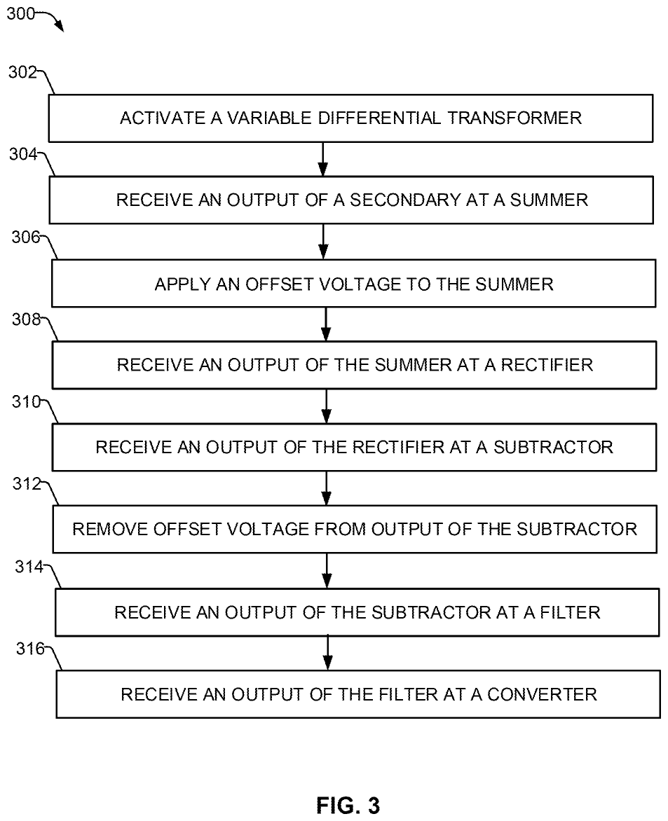

FIG. 3 illustrates an example method 300 of implementing a control system (e.g., control system 100) to measure a change position or orientation of a variable differential transformer (e.g., LVDT 10) and thereby to provide an output with a single rail bias. In describing the method 300, reference will be made to FIGS. 4A to 4D, which provide graphical representations of example waveforms at the various stages and/or from the various circuits.

In block 302, the LVDT is activated. For instance, a power input can be received at the LVDT (e.g., from an AC power source 90), as provided in FIG. 4A. Once energized, movement of an associated actuator causes a core assembly (e.g., core assembly 14) to move relative to a primary and one or more secondary coils (e.g., coils 22, 102A, 102B). In block 304, an output of the secondary coils is received at a summer or summing circuit (e.g., summer 104A, 104B). The example summing circuit can have an adjustable gain, which can be tailored for a specific application.

As described herein, two secondary coils are employed, one on either side of the primary coil 22. Thus, each secondary coil 102A and 102B generate an output, each of which is received a respective summer circuit 104A and 104B. In conventional systems, the phase bias can lead to discrepancies in reading of the output. In the disclosed solution, provided in block 306, a voltage offset circuit (e.g., voltage offset circuit 114) applies an offset voltage to the summing circuit, represented in the waveform of FIG. 4B.

In block 308, the output of the summing circuit is received at a rectifier circuit (e.g., rectifier 106A, 106B). The example rectifier circuit can be a two-stage op-amp, full-wave rectifier type, although other rectifier circuits may be equally suitable for a given application.

In block 310, an output of the rectifier circuit (represented in FIG. 4C) is received at a subtractor circuit (e.g., subtractor 108A, 108B), where the offset voltage is removed in block 312. The example subtractor circuit can be a voltage divider type, although other subtractor circuits may be equally suitable for a given application.

In block 314, an output of the subtractor circuit (represented in FIG. 4D) is received at a filter stage (e.g., active filter 110A). The example active filter and/or filter circuit can be a Sallen-Key type active filter, although other filters and/or filter circuits may be equally suitable for a given application. An output of the filter stage (represented in FIG. 4E) can be transmitted to a converter for further processing and/or transmission (e.g., ADC 112A, 112B).

Although several examples are provided with reference to linear VDTs, in some instances the concepts disclosed herein are equally applicable to rotational variable differential transformers (RVDT). For instance, RVDTs are useful in measuring angular displacement (e.g., from a device rotating with respect to a null position). An example RVDT can include a rotor configured to turn, such as by an applied force. The RVDT outputs a signal proportional to the physical, angular displacement of the rotor shaft, which can be measured in accordance with the principles described herein.

As utilized herein, “and/or” means any one or more of the items in the list joined by “and/or”. For example, “x and/or y” means any element of the three-element set {(x), (y), (x, y)}. Similarly, “x, y, and/or z” means any element of the seven-element set {(x), (y), (z), (x, y), (x, z), (y, z), (x, y, z)}. As utilized herein, the term “module” refers to functions that can be implemented in hardware, software, firmware, or any combination of one or more thereof. As utilized herein, the term “exemplary” means serving as a non-limiting example, instance, or illustration.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A control system for a variable differential transformer comprising:
a summing circuit to receive an output from two secondary coils, each of the two secondary coils to generate an induced voltage in response changes in position of a core assembly relative to a primary coil and the two secondary coils;
a rectifier circuit to receive a summing circuit output; and
a voltage offset circuit operable to:
add a voltage offset value to the summing circuit output; and
remove the voltage value from the rectifier circuit output.

2. The control system of claim 1, further comprising an active filter to filter the rectifier circuit output.

3. The control system of claim 2, wherein an active filter output is provided to an analog-to-digital-converter to generate an electronic signal corresponding to the changes in position of the core assembly.

4. The control system of claim 2, wherein the active filter is a Sallen-Key type filter.

5. The control system of claim 1, wherein the summing circuit is an adjustable gain type circuit.

6. The control system of claim 1, wherein the rectifier circuit is a two-stage op-amp, full-wave rectifier type.

7. The control system of claim 1, wherein the rectifier circuit is a single rail bias op-amp circuit.

8. The control system of claim 1, wherein the variable differential transformer is a linear variable differential transformer.

9. A variable differential transformer system comprising:
a primary coil to receive a power input;
a core assembly to move relative to the primary coil;
two secondary coils to generate an induced voltage based on a voltage in the primary coil in response to the movement of the core assembly; and
a control system comprising:
a summing circuit to receive an output from two secondary coils, each of the two secondary coils to generate an induced voltage in response changes in position of the core assembly relative to a primary coil and the two secondary coils;
a rectifier circuit to receive a summing circuit output; and
a voltage offset circuit operable to add a voltage offset value to the summing circuit output.

10. The variable differential transformer system of claim 9, further comprising a Sallen-Key type filter to filter the rectifier circuit output.

11. The variable differential transformer system of claim 9, wherein the rectifier circuit is a single rail bias op-amp circuit.

12. The variable differential transformer system of claim 9, wherein the variable differential transformer is a linear variable differential transformer.

13. The variable differential transformer system of claim 9, wherein the variable differential transformer is a rotatable variable differential transformer.

14. The variable differential transformer system of claim 9, further comprising a housing to contain one or more of the primary coils, the core assembly, and the two secondary coils.

15. The variable differential transformer system of claim 14, wherein the control system is collocated with the housing.

16. The variable differential transformer system of claim 14, wherein the control system is remote from the housing.

17. A method of implementing a control system to measure a change position or orientation of a variable differential transformer comprising:
receiving an output from two secondary coils at a summer circuit;
applying an offset voltage to an output of the summer circuit;
receiving the summer circuit output at an op-amp rectifier;
receiving an op-amp rectifier output at a subtractor circuit; and
removing the offset voltage from an output of the subtractor circuit.

18. The method of claim 17, further comprising receiving the subtractor circuit output at a filter stage.

19. The method of claim 17, further comprising receiving the filter stage output at an analog-to-digital-converter.

20. The method of claim 17, wherein the rectifier circuit is a single rail bias op-amp circuit.
